(19) United States
(12) Patent Application Publication
(10) Pub. No.: US 2004/0203938 A1
(43) Pub. Date: Oct. 14, 2004

(54) Weighted average traffic calculation and resource allocation system for voice and data services on a single wireless carrier

(76) Inventor: Narayan A. Kulkarni, Wheaton, IL (US)

Correspondence Address: PATTON BOGGS, 1660 LINCOLN ST, SUITE 2050, DENVER, CO, 80264, US

(21) Appl. No.: 10/378,687

(22) Filed: Mar. 4, 2003

(51) Int. Cl. H04Q 7/20

(52) U.S. Cl. 455/464; 455/450; 455/452.1

(57) ABSTRACT

In order to deal with a dynamically changing mix of traffic presented to the carrier facilities, the resource allocation system calculates the equivalent radio frequency load served by the carrier for the present mix of the various services that are presented to the carrier facility. This calculation enables the call processing process in the Base Station and the associated Mobile Switching Center to dynamically allocate the system resources and packet data rate allocation to improve data throughput and Radio Frequency capacity of the carrier facilities. The calculation of the equivalent radio frequency capacity utilization involves usage based Radio Frequency capacity estimation for a mix of second generation (2G) voice, third generation (3G) voice, third generation (3G) packet data, and Short Message Service (SMS) on the same carrier.

### FIELD OF THE INVENTION

This invention relates to carrier facilities in wireless communication networks and to the estimation of the radio frequency capacity of such carrier facilities.

### PROBLEM

It is a problem in wireless communication networks that the need to concurrently serve many subscribers with the limited bandwidth available in second generation (2G) wireless communication networks has prevented the provision of wide bandwidth communication services, such as data, to these subscribers. The third generation (3G) wireless communication systems, as specified by the 3GPP--WCDMA and 3GPP2--CDMA2000 requirements for cellular communications, represent a step toward solving this problem. The third generation (3G) wireless communication systems support the provision of advanced packet data services.

However, the provision of third generation (3G) wireless communication systems in the existing second generation (2G) wireless communication network presents significant traffic engineering problems. Present Radio Frequency engineering methods do not account for the varying Erlang limits for second generation (2G) and third generation (3G) technologies and for the inclusion of packet data into the switched traffic. Thus, present wireless communication systems inefficiently deal with the mix of second generation (2G) voice and data, third generation (3G) voice, third generation (3G) packet data, and Short Message Service (SMS) messages that are presented for transmission on the carrier facilities of the wireless communication network.

### SOLUTION

The above-described problems are solved by the present weighted average traffic calculation and resource allocation system for voice and data services on a single wireless carrier, termed “resource allocation system” herein, that is operational in a wireless communication system that is equipped with and manages carrier facilities.

In order to deal with a dynamically changing mix of traffic presented to the carrier facilities, the resource allocation system calculates the equivalent radio frequency load served by the carrier for the present mix of the various services that are presented to the carrier facility. This calculation enables the call processing process in the Base Station and the associated Mobile Switching Center to dynamically allocate the system resources and packet data rate allocation to improve data throughput and Radio Frequency capacity of the carrier facilities. The calculation of the equivalent radio frequency capacity utilization involves usage based Radio Frequency capacity estimation for a mix of second generation (2G) voice, third generation (3G) voice, third generation (3G) packet data, and Short Message Service (SMS) on the same carrier.

The resource allocation system maintains a rolling average count of Erlang traffic in a base station, based on sample measurements on Walsh function usage over a predetermined measurement interval and packet data frame counts, for second generation (2G) voice and data, third generation (3G) voice, third generation (3G) packet data, and Short Message Service (SMS) messages for a carrier. The resource allocation system then uses a pre-determined weighting system, based on the facilities capacity of various services, to calculate the average weighted capacity utilization for various services to determine how much capacity is available for allocation to each type of service. Based on the weighted capacity utilization calculation, the resource allocation system makes dynamic allocation of data rates for packet data calls and allocation of resources for voice calls. Also, based on the calculated weighted average Erlang value, the resource allocation system makes decisions regarding the blocking of calls or redirecting calls to less loaded carriers.

### BRIEF DESCRIPTION OF THE DRAWINGS

FIG. 1 illustrates in block diagram form the present resource allocation system and the overall architecture of a wireless communications network in which it is operational; and

FIGS. 2-4 illustrate in flow diagram form the operation of the present resource allocation system.

### DETAILED DESCRIPTION

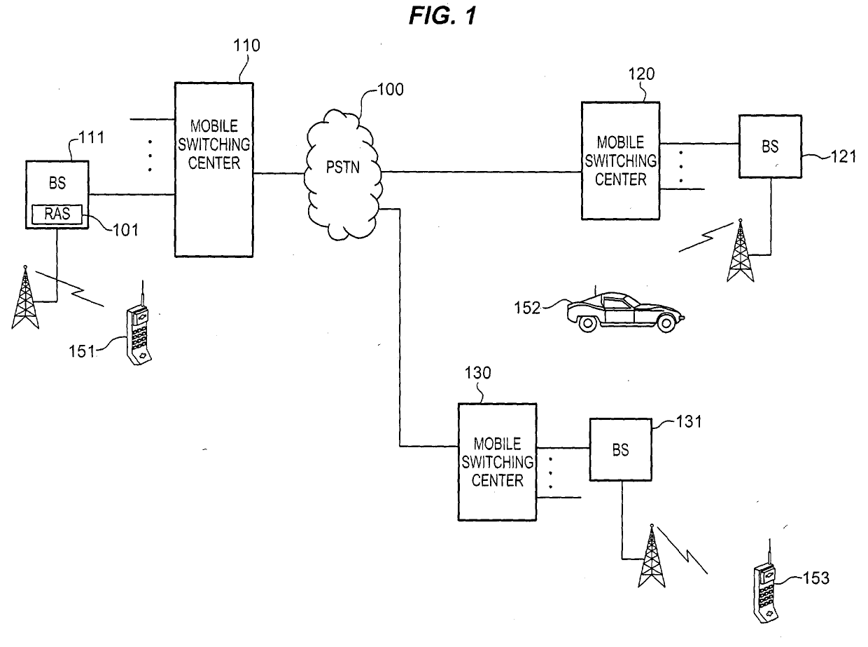

FIG. 1 illustrates in block diagram form the present resource allocation system 101 and the overall architecture of a wireless communications network in which it is operational. A typical wireless communications network comprises a plurality of second generation (2G) 110, 120 and third generation (3G) 130 switching systems, each of which serve a plurality of base stations 111, 121, 131 and the cells which they generate. The wireless communication network provides the service of connecting wireless communication customers, each having a wireless subscriber device 151-153, to both land-based customers who are served by the common Carrier Public Switched Telephone Network (PSTN) 100 as well as other wireless communication customers. In such a network, all incoming and outgoing calls are routed through Mobile Switching Centers (MSC) 110, 120, 130. Each cell site generated by the plurality of base stations 111, 121, 131 contains a group of radio transmitters and receivers, with each transmitter-receiver pair operating on a pair of radio frequencies to create a communication channel: one frequency to transmit radio signals to the wireless subscriber device and the other frequency to receive radio signals from the wireless subscriber device. The Mobile Switching Centers 110, 120, 130, in conjunction with their Home Location Register (HLR) and Visitor Location Register (VLR) (not shown), manage subscriber registration, subscriber authentication, and the provision of wireless services such as voice mail, call forwarding, roaming validation and so on.

The control channels that are available in this system are used to setup the communication connections between the subscriber stations 151-153 and the Base Stations 111, 121, 131. With a typical Code Division Multiple Access (CDMA) system, 64 Walsh codes are used to differentiate among the mobile subscriber stations and generally all of these codes are not all are used in a typical cell site. When a call is initiated, the control channel is used to communicate between the wireless subscriber device 151-153 involved in the call and the local serving Base Station 111, 121, 131. The control messages locate and identify the wireless subscriber device 151-153, determine the dialed number, and identify an available voice/data communication channel consisting of a pair of radio frequencies and Walsh orthogonal coding which is selected by the Base Station 111, 121, 131 for the communication connection. The radio unit in the wireless subscriber device 151-153 re-tunes the transmitter-receiver equipment contained therein to use these designated radio frequencies and selected Walsh orthogonal coding. Once the communication connection is established, the control messages are typically transmitted to adjust transmitter power and/or to change the transmission channel when required to handoff this wireless subscriber device 151-153 to an adjacent cell, when the subscriber moves from the present cell to one of the adjoining cells. The transmitter power of the wireless subscriber device 151-153 is regulated since the magnitude of the signal received at the Base Station 111, 121, 131 is a function of the subscriber station transmitter power and the distance from the Base Station 111, 121, 131. Therefore, by scaling the transmitter power to correspond to the distance from the Base Station 111, 121, 131, the received signal magnitude can be maintained within a predetermined range of values to ensure accurate signal reception without interfering with other transmissions in the cell.

The voice communications between a calling party's wireless subscriber device 151 and other subscriber stations, such as the called party's wireless subscriber device 153, is effected by routing the communications received from the wireless subscriber device 151 through the Base Station 111, Mobile Switching Center 110 and trunks to the Public Switched Telephone Network (PSTN) 100, where carrier facilities multiplex a plurality of voice and data communications from numerous Mobile Switching Centers into a single channel for transmission to a selected destination Mobile Switching Center 130, where the calling party's voice communication is excerpted from the carrier and routed to the Base Station 131 that served the called party's wireless subscriber device 153.

Carrier Facilities Management

The characteristics of telephone traffic necessarily influence the design and capacity of switching systems. The number, content and duration of telephone calls affect the amount of carrier facilities required to serve these calls. It is essential for good service that adequate switching paths and carrier facilities be provided, but in the interest of economy, the number of paths and carrier facilities should be kept small. Telephone traffic is traditionally defined as the traffic intensity. This was traditionally calculated as the product on the number of calls during the period of time and the average holding time per call. Alternatively, this measure can be expressed as the product of the average number of occupied circuits during the period and the duration of the period in time units. Traffic intensity is expressed in terms of the metric CCS or Erlangs, where Erlang is defined as a dimensionless unit of the average traffic intensity of a facility during a period of time, usually a busy hour. Erlangs is expressed as a number between 0 and 1, inclusive, is representative of the ratio of (a) the time during which a facility is continuously or cumulatively occupied to (b) the time that the facility is available for occupancy. Communications traffic, measured in erlangs for a period of time, and offered to a group of shared facilities, such as a trunk group, is equal to the average of the traffic intensity, in Erlangs for the same period of time, of all individual sources, such as telephones, that share and are served exclusively by this group of facilities.

TABLE 1
Radio Configurations - Vocoder Rate Supported by 2G and 3G:

| | | | Walsh | Physical Layer |
|---|---|---|---|---|
| Forward | Generation | Rate Set | Function size | Characteristics |
| FCH | | | | |
| RC | | | | |
| RC1 | 2G | RS1 (8k) | 64 | R = ½ BPSK* |
| RC2 | 2G | RS2 (13k) | 64 | R = ½ BPSK |
| RC3 | 3G | RS1 (8k) | 64 | R = ¼ QPSK |
| RC4 | 3G | RS1 (8k) | 128 | R = ½ QPSK |
| RC5 | 3G | RS2 (13k) | 64 | R = ¼ QPSK |
| | | | | Physical Layer |
| Reverse | Generation | Rate Set | Reverse Pilot | Characteristics |
| FCH | | | | |
| RC | | | | |
| RC1 | 2G | RS1 (8k) | No | R = ⅓ 64-ary |
| RC2 | 2G | RS2 (13k) | No | R = ½ 64-ary |
| RC3 | 3G | RS1 (8k) | Yes | R = ¼ BPSK |
| RC4 | 3G | RS2 (13k) | Yes | R = ¼ BPSK |

where BPSK = Binary Pulse Shift Keying;
QPSK = Quadrature Phase Shift Keying;
and FCH = Fundamental Channel

With carrier facilities, the Radio Frequency capacity of a carrier is defined in terms of Erlang traffic that can be transmitted on the carrier. For example, for second generation (2G) voice traffic termed Radio Configuration 1, the capacity for a standard carrier facility is specified at about 12 Erlangs and for a third generation (3G) voice traffic, termed Radio Configuration 3 the capacity is specified at about 21.6 Erlangs per carrier. These present metrics are proposed to be revised in view of the use of improved vocoders:

| Present: | Proposed: |
|---|---|
| 1. Second Generation (2G) | Second Generation (2G) with |
| (Radio Configuration 1) | EVRC vocoder |
| 2. Third generation (3G) | Third Generation (3G) with |
| (Radio Configuration 3) voice | EVRC vocoder for voice |
| 3. Third Generation (3G) | Third Generation (30) with |
| (Radio Configuration 3) data | ECRC vocoder for packet data |

Thus, the capacity for third generation (3G) voice is about twice that set for second generation (2G) voice and for third generation (3G) packet data the capacity is about 30% more than third generation (3G) voice. Therefore, with the introduction of third generation (3G) systems, the carrier has a mix of traffic types and the capacity of a particular carrier facility is a function of the dynamically changing mix of traffic that is submitted to the carrier facility.

In order to deal with a dynamically changing mix of traffic presented to the carrier facilities, the resource allocation system calculates the equivalent radio frequency load served by the carrier for the present mix of the various services that are presented to the carrier facility. This calculation enables the call processing process in the Base Station 111 and the associated Mobile Switching Center 110 to dynamically allocate the system resources and packet data rate allocation to improve data throughput and Radio Frequency capacity of the carrier. The calculation of the equivalent radio frequency capacity utilization involves usage based Radio Frequency capacity estimation for a mix of second generation (2G) voice and data, third generation (3G) voice, third generation (3G) packet data, and Short Message Service (SMS) messages on the same carrier.

The resource allocation system maintains a rolling average count of Erlang traffic in a base station, based on sample measurements on Walsh function usage over a predetermined measurement interval and packet data frame counts, for second generation (2G) voice and data, third generation (3G) voice, third generation (3G) packet data, and Short Message Service (SMS) messages for a carrier. The resource allocation system then uses a pre-determined weighting system, based on the capacity of various services, to calculate the average weighted capacity utilization for various services to determine how much capacity is available for allocation to each type of service. Based on the weighted capacity utilization calculation, the resource allocation system makes dynamic allocation of data rates for packet data calls and allocation of resources for voice calls. Also, based on the calculated weighted average Erlang value, the resource allocation system makes decisions regarding the blocking of calls or redirecting calls to less loaded carriers.

Operation of the Resource Allocation System

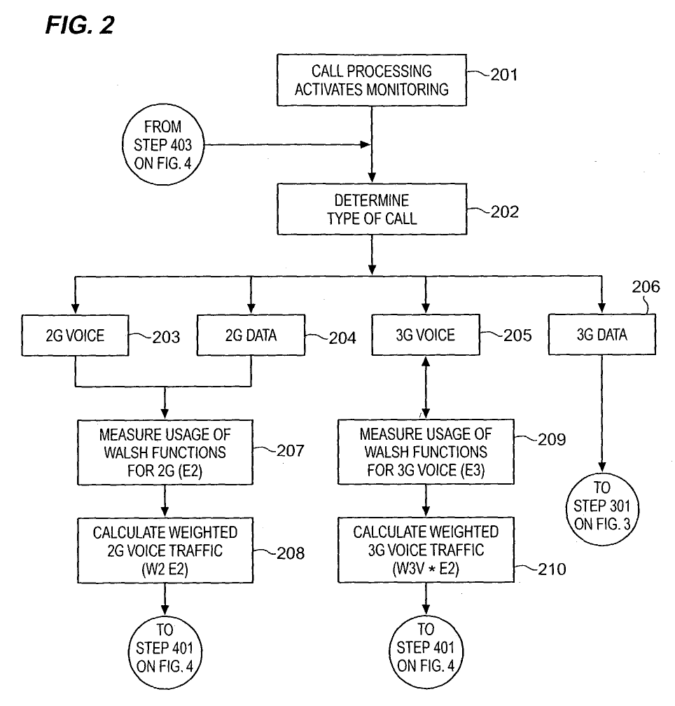

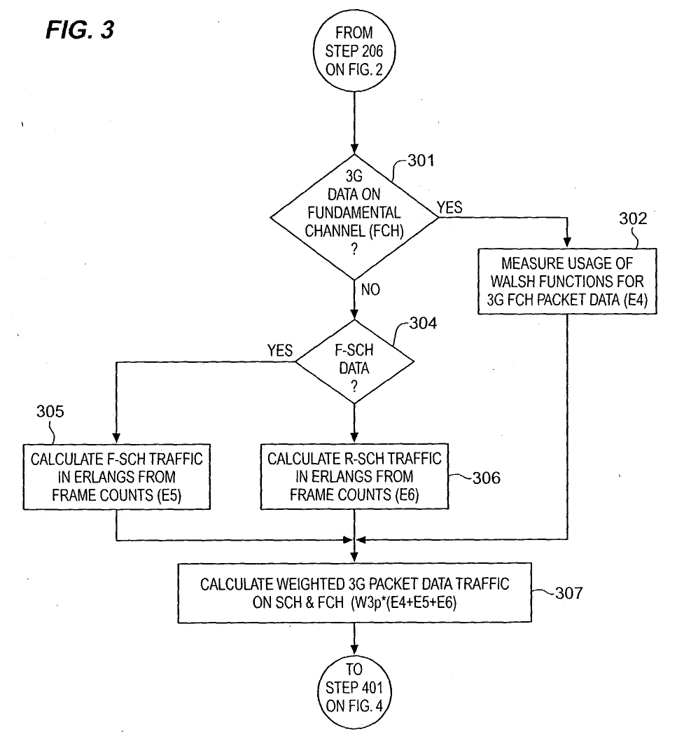

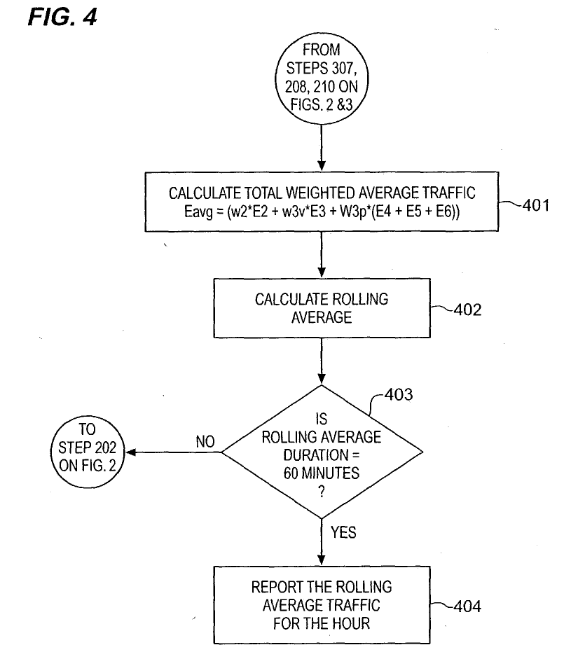

FIGS. 2-4 illustrate in flow diagram form the operation of the present resource allocation system 101. At step 201, the wireless communication network call processing in Base Station 111 activates the resource allocation system 101 to perform a measurement of the average traffic carried on a particular carrier, which is an air interface between the Base Station 111 and a mobile subscriber station. It is important to note that the terms “carrier” and “frequency” are often used interchangeably, since they both refer to the same thing. Note also that a carrier /frequency can be common to 2G and 3G. Both 2G and 3G traffic can be sent on the same carrier). At step 202, the resource allocation system 101 determines the type of call submitting traffic to the selected carrier facility. For second generation (2G) voice traffic, identified at step 203, and second generation (2G) data traffic, identified at step 204, the resource allocation system 101 at step 207 measures the usage of Walsh functions (E2) for a predetermined measurement interval. The usage of Walsh functions in a Base Station is indicative of the radio frequency channels used by subscribers to implement call connections. At step 208, the resource allocation system 101 calculates the weighted second generation (2G) traffic submitted to the selected carrier facility for the present predetermined measurement interval by multiplying the measured usage of Walsh functions (E2) by a weighting factor (W2) to compute the weighted second generation (2G) traffic submitted to the selected carrier facility for the present predetermined measurement interval. For example, when traffic is sent, the system scans Walsh codes every 10 seconds, looks at the technology and type of service and records the traffic for that technology and service. For 3G FCH and SCH, the traffic is calculated by using the number of frames transmitted or received and NOT by use of Walsh functions) For third generation (3G) voice traffic, identified at step 205, the resource allocation system 101 at step 209 measures the usage of Walsh functions (E3) for the predetermined measurement interval. For third generation (3G) data traffic, identified at step 206, the resource allocation system 101 at step 209 must execute the process illustrated in flow diagram form in FIGS. 3 and 4 to determine this component of traffic submitted to the selected carrier facility for the predetermined measurement interval. This is due to the fact that third generation (3G) data traffic can be carried in many modes: on the Fundamental Channel (FCH), the Forward Supplemental Channel (F-SCH), the Reverse Supplemental Channel (R-SCH), and each of these components must be measured and weighted separately.

In particular, at step 301, the resource allocation system 101 determines the magnitude of the third generation (3G) data traffic present on the Fundamental Channel (FCH) by branching to step 302 where it determines the usage of Walsh functions (E4) for the predetermined measurement interval to identify the quantity of packet data carried on the Fundamental Channel (FCH) by this selected carrier facility. At step 301, to compute the component of data traffic associated with the Forward Supplemental Channel (F-SCH) and the Reverse Supplemental Channel (R-SCH), processing advances to step 304 to process the measurement of these components individually. At step 305, the resource allocation system 101 measures the magnitude of the third generation (3G) data traffic present on the Forward Supplemental Channel (F-SCH) by calculating the traffic in Erlangs (ES) from the frame counts associated with the Forward Supplemental Channel (F-SCH). At step 306, the resource allocation system 101 measures the magnitude of the third generation (3G) data traffic present on the Reverse Supplemental Channel (R-SCH) by calculating the traffic in Erlangs (E6) from the frame counts associated with the Reverse Supplemental Channel (R-SCH). Finally, at step 307, the resource allocation system 101 calculates the weighted third generation (3G) traffic submitted on the Supplemental Channel (SCH) to the selected carrier facility for the present predetermined measurement interval by multiplying the measured usage of Walsh functions (E4, E5, E6) attributable to each of the above-noted components by a weighting factor (W3p) to compute the weighted third generation (3G) packet data traffic submitted to the selected carrier facility on the Fundamental Channel (FCH) for the present predetermined measurement interval (W3p*(E4+E5+E6)).

At step 401, the resource allocation system 101 determines the composite weighted average traffic for this present predetermined measurement interval by summing all of the components determined above, where the composite weighted average traffic for this present predetermined measurement interval Eave=(W2*E2+W3v*E3+W3p*(E4+E5+E6)). At step 402, the resource allocation system 101 computes the rolling average for a predetermined rolling average monitoring interval, such as 60 minutes, using the results from step 401 and the previously accumulated composite weighted average traffic for prior predetermined measurement intervals contained within the present predetermined rolling average monitoring interval. At step 403 the resource allocation system 101 determines whether the present rolling average monitoring interval is concluded and, if not, processing returns to step 202 for another computation of composite weighted average traffic for a predetermined measurement interval. If the resource allocation system 101 determines that the present rolling average monitoring interval is concluded, processing advances to step 404, where the rolling average traffic for the present rolling average monitoring interval is reported to the network controller for use in carrier facilities management.

Thus, the resource allocation system 101 measures each component of traffic submitted to the selected carrier facility in order to identify the contribution of each-component to the rolling average traffic for the present rolling average monitoring interval. By using a weighting scheme to modulate the contribution of each component of traffic as a function of the characteristics of the component in terms of its impact on facilities usage, the resource allocation system makes a dynamic allocation of data rates for packet data calls and an allocation of resources for voice calls.

### EXAMPLE CALCULATION:

In order to determine the weighting factors attributable to the various components of traffic that can be handled by a carrier facility, some basic assumptions must be made in terms of the impact that a type of traffic has on facilities usage. Assume that for a particular type of carrier facility, the following metrics are determined:

Carrier capacity for second generation (2G) (Radio Configuration 1) voice and data=12.00 Erlangs

Carrier capacity for third generation (3G) (Radio Configuration 3) voice=21.60 Erlangs

Carrier capacity for third generation (3G) packet data=28.00 Erlangs

In order to simplify the computations of the capacity usage, the Radio Frequency capacity is normalized for the carrier based on the third generation (3G) Radio Configuration 3 voice capacity of 21.60 Erlangs. Therefore, it is determined that:

Weight for the second generation (2G) (Radio Configuration 1) voice and data:

W2=(21.60/12.00)=1.8

Weight for the third generation (3G) (Radio Configuration 3) voice:

W3v=(21.60/21.60)=1

Weight for the third generation (3G) packet data:

W3p=(21.60/28.00)=0.77

These weighting factors therefore represent the adjustment of the measured values of actual traffic submitted to a carrier facility that are appropriate in managing the carrier facility.

Assume that for a present predetermined measurement interval the following average traffic is measured for a selected carrier:

Second generation (2G) (Radio Configuration 1) voice and data=E2=5 Erlangs

Third generation (3G) (Radio Configuration 3) voice=E3=7 Erlangs

Third generation (3G) packet data=E4+E5+E6=6 Erlangs

Then the composite weighted average traffic for this present predetermined measurement interval is:

$$\begin{matrix}Eave = ( W2 * E2 + W3v * E3 + W3p * ( E4 + E5 + E6 ) ) \\ = 1.8 * ( 5.0 ) + 1.0 * ( 7 ) + 0.77 * ( 6.0 ) \\ = 9.0 + 7.0 + 4.6 \\ = 20.6 Erlangs\end{matrix}$$

The following observations can be used from the above sample data for the present predetermined measurement interval in making determinations regarding call processing:

1. The second generation (2G) voice traffic is approximately 44% of the total traffic.

2. The third generation (3G) voice traffic is approximately 33% of the total traffic.

3. The third generation (3G) packet data traffic is approximately 23% of the total traffic.

Summary

Thus, the resource allocation system calculates the equivalent radio frequency load served by the carrier for the present mix of the various services that are presented to the carrier facility to enable the call processing process in the Base Station and the associated Mobile Switching Center to dynamically allocate the system resources and packet data rate allocation to improve data throughput and Radio Frequency capacity of the carrier facilities.

What is claimed:

1. A resource allocation system operational in a wireless communication system for determining capacity utilization of carrier facilities, comprising:
2G voice/data measurement means for measuring carrier facilities capacity usage by second generation call connections for a present predetermined measurement interval;
3G voice measurement means for measuring carrier facilities capacity usage by third generation voice call connections for said present predetermined measurement interval;
3G data measurement means for measuring carrier facilities capacity usage by third generation data call connections for said present predetermined measurement interval; and
averaging means for computing a composite weighted average traffic for said carrier facilities for said present predetermined measurement interval by summing weighted products of said carrier facilities capacity usage by second generation call connections for said present predetermined measurement interval, carrier facilities capacity usage by third generation voice call connections for said present predetermined measurement interval, and said carrier facilities capacity usage by third generation data call connections for said present predetermined measurement interval.

2. The resource allocation system of claim 1 wherein said 2G voice/data measurement means comprises:
Walsh function measurement means for measuring usage of Walsh functions in a base station of said wireless communication system for said present predetermined measurement interval.

3. The resource allocation system of claim 1 wherein said 3G voice measurement means comprises:
Walsh function measurement means for measuring usage of Walsh functions in a base station of said wireless communication system for said present predetermined measurement interval.

4. The resource allocation system of claim 1 wherein said 3G data measurement means comprises:
Walsh function measurement means for measuring usage of Walsh functions in a selected Fundamental Channel in a base station of said wireless communication system for said present predetermined measurement interval.

5. The resource allocation system of claim 4 wherein said 3G data measurement means further comprises:
forward frame measurement means for measuring frame counts in a selected Forward Supplemental Channel in a base station of said wireless communication system for said present predetermined measurement interval.

6. The resource allocation system of claim 5 wherein said 3G data measurement means further comprises:
reverse frame measurement means for measuring frame counts in a selected Reverse Supplemental Channel in a base station of said wireless communication system for said present predetermined measurement interval.

7. The resource allocation system of claim 6 wherein said averaging means comprises:
measurement weighting means for multiplying each of said measured usage of Walsh functions in said selected Fundamental Channel, said measured frame counts in said selected Forward Supplemental Channel, and said measured frame counts in said selected Reverse Supplemental Channel by a corresponding weighting factor to produce 3G data weighted measurements.

8. The resource allocation system of claim 7 wherein said averaging means further comprises:
voice call measurement weighting means for multiplying each of said measured carrier facilities capacity usage by second generation call connections and said measured carrier facilities capacity usage by second generation call connections by a corresponding weighting factor to produce 2G and 3G voice weighted measurements; and
rolling average computation means for summing said 3G data weighted measurements and said 2G and 3G voice weighted measurements for said present predetermined measurement interval along with sums of said 3G data weighted measurements and said 2G and 3G voice weighted measurements for prior predetermined measurement intervals to produce data indicative of a rolling average of composite weighted average traffic.

9. The resource allocation system of claim 8 further comprising:
data output means for transmitting said data indicative of a rolling average to a controller in said base station of said wireless communication system.

10. A method of allocating resources in a wireless communication system for determining capacity utilization of carrier facilities, comprising:
measuring carrier facilities capacity usage by second generation call connections for a present predetermined measurement interval;
measuring carrier facilities capacity usage by third generation voice call connections for said present predetermined measurement interval;
measuring carrier facilities capacity usage by third generation data call connections for said present predetermined measurement interval; and
computing a composite weighted average traffic for said carrier facilities for said present predetermined measurement interval by summing weighted products of said carrier facilities capacity usage by second generation call connections for said present predetermined measurement interval, carrier facilities capacity usage by third generation voice call connections for said present predetermined measurement interval, and said carrier facilities capacity usage by third generation data call connections for said present predetermined measurement interval.

11. The method of allocating resources of claim 10 wherein said step of measuring carrier facilities capacity usage by second generation call connections comprises:
measuring usage of Walsh functions in a base station of said wireless communication system for said present predetermined measurement interval.

12. The method of allocating resources of claim 10 wherein said step of measuring carrier facilities capacity usage by third generation voice call connections comprises:
measuring usage of Walsh functions in a base station of said wireless communication system for said present predetermined measurement interval.

13. The method of allocating resources of claim 10 wherein said step of measuring carrier facilities capacity usage by third generation data call connections comprises:
measuring usage of Walsh functions in a selected Fundamental Channel in a base station of said wireless communication system for said present predetermined measurement interval.

14. The method of allocating resources of claim 13 wherein said step of measuring carrier facilities capacity usage by third generation data call connections further comprises:
measuring frame counts in a selected Forward Supplemental Channel in a base station of said wireless communication system for said present predetermined measurement interval.

15. The method of allocating resources of claim 14 wherein said step of measuring carrier facilities capacity usage by third generation data call connections further comprises:
measuring frame counts in a selected Reverse Supplemental Channel in a base station of said wireless communication system for said present predetermined measurement interval.

16. The method of allocating resources of claim 15 wherein said step of averaging comprises:
multiplying each of said measured usage of Walsh functions in said selected Fundamental Channel, said measured frame counts in said selected Forward Supplemental Channel, and said measured frame counts in said selected Reverse Supplemental Channel by a corresponding weighting factor to produce 3G data weighted measurements.

17. The method of allocating resources of claim 16 wherein said step of averaging further comprises:
multiplying each of said measured carrier facilities capacity usage by second generation call connections and said measured carrier facilities capacity usage by second generation call connections by a corresponding weighting factor to produce 2G and 3G voice weighted measurements; and
summing said 3G data weighted measurements and said 2G and 3G voice weighted measurements for said present predetermined measurement interval along with sums of said 3G data weighted measurements and said 2G and 3G voice weighted measurements for prior predetermined measurement intervals to produce data indicative of a rolling average of composite weighted average traffic.

18. The method of allocating resources of claim 17 further comprising:
transmitting said data indicative of a rolling average to a controller in said base station of said wireless communication system.
